(19) United States
(12) Patent Application Publication
(10) Pub. No.: US 2022/0341330 A1
(43) Pub. Date: Oct. 27, 2022

(54) FAN BLADES FOR FRANGIBILITY

(71) Applicant: GENERAL ELECTRIC COMPANY, Schenectady, NY (US)

(72) Inventors: Nitesh Jain, Bengaluru (IN); Nicholas Joseph Kray, West Chester, OH (US); David Crall, West Chester, OH (US)

(21) Appl. No.: 17/241,948

(22) Filed: Apr. 27, 2021

(51) Int. Cl. F01D 5/14

(52) U.S. Cl. CPC F01D 5/147; B33Y 80/00

(57) ABSTRACT

Fan blades for frangibility are disclosed. An example airfoil for use in a gas turbine engine includes a root portion to be disposed adjacent to a disk of the gas turbine engine, a tip portion including a cavity disposed therein, and wherein the tip portion and cavity are configured to fragment when exposed to a threshold force corresponding to a high-stress event.

### FIELD OF THE DISCLOSURE

This disclosure relates generally to turbine engines and, more particularly, to fan blades for frangibility.

### BACKGROUND

In recent years, turbine engines have been increasingly utilized in a variety of applications and fields. Turbine engines are intricate machines with extensive availability, reliability, and serviceability requirements. Turbine engines include fan blades. The fan blades spin at high speed and subsequently compress the airflow. The high-pressure compressor then feeds the pressurized airflow to a combustion chamber to generate a high-temperature, high-pressure gas stream.

### BRIEF SUMMARY

Aspects and advantages of the disclosure will be set forth in part in the following description, or may be obvious from the description, or may be learned through practice of the disclosure. In one aspect, the present disclosure is directed towards an airfoil. The airfoil disclosed herein includes a root portion to be coupled to a disk of the gas turbine engine, a tip portion including a cavity disposed therein, the tip portion to be disposed adjacent to an abradable layer of the gas turbine engine, and wherein the tip portion and cavity are configured to fragment when exposed to a threshold force corresponding to the tip portion exceeding the abradable layer.

A further aspect of the disclosure is directed towards a gas turbine engine. The gas turbine engine herein includes a casing including an abradable layer, a rotor disk, and an airfoil coupled to the rotor disk, the airfoil comprising a root portion coupled to a disk of the gas turbine engine, a tip portion including a cavity disposed therein, the tip portion disposed adjacent to an abradable layer of the gas turbine engine, and wherein the tip portion and cavity are configured to fragment when exposed to a threshold force corresponding to the tip portion exceeding the abradable layer.

These and other features, aspects, and advantages of the disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure, including the best mode thereof, directed to one of ordinary skill in the art, is set forth in the specification, which makes reference to the appended Figs., in which:

FIG. 1 is a schematic cross-sectional view of a gas turbine engine in which the teachings of this disclosure may be implemented;

FIG. 2 is a cross-sectional view of a prior art fan blade assembly in the gas turbine engine of FIG. 1;

FIG. 3 is a cross sectional view of the example prior fan blade of FIG. 2;

FIG. 4A is a perspective view of an example fan blade including a lattice tip implemented in accordance with the teachings of this disclosure;

FIG. 4B is a perspective view of another example fan blade including a lattice tip implemented in accordance with the teachings of this disclosure;

FIG. 4C is a cross-sectional view of the tip of the fan blade of FIGS. 4A and/or FIG. 4B;

FIG. 5A is a perspective view of an example fan blade including a hollow tip implemented in accordance with the teachings of this disclosure;

FIG. 5B is a perspective view of another example fan blade including a hollow tip implemented in accordance with the teachings of this disclosure;

FIG. 5C is a cross-sectional view of the tip of the fan blade of FIGS. 5A and/or FIG. 5B;

FIG. 6 illustrates an example flowchart representative of a method to be used to manufacture the fan blade of FIGS. 4A, 4B, 5A and/or 5B; and

FIG. 7 is a block diagram of an example processor platform structured to execute the instructions of FIG. 6.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts. Stating that any part is “adjacent” to another part means the two parts are near one another and that there is no intermediate part between the two parts. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Fan cases prevent fan blades from exiting the engine in the event of a blade out event. The outer layers of a fan case of a gas turbine engine are typically composed of hard materials, such as composites and/or metals. Fan cases typically include a trench filler system beneath the outer layers, which is rubbed against and abraded by fan blades during high-stress and/or blade out events. Trench filler systems are configured to abrade when rubbed against and thus, prevent harsh rub conditions during blade out events. Without a trench filler system, the blades would rub against the harder outer fan case layers, which can cause comparatively higher loads on engine components than those encountered during normal operation of the engine. As such, the use of a trench filler system reduces the design strength requirements of engine components and, thus, reduces the overall weight of the engine. However, trench filler systems are composed of expensive materials and contribute to the overall weight of the engine. Accordingly, removing the trench filler system from the engine, while still maintaining the design benefits of the trench filler system would decrease gas turbine engine weight and cost.

Examples provided herein include fan blade configurations that obviate the need for trench filler systems in fan cases. Fan blade configurations provided herein are configured to fragment against the fan casing during high rub situations, like those encountered during high-stress events (e.g., bird ingestion, fan blade outs, etc.). The example fan blades disclosed herein are frangible and maintain the strength and durability associated with prior art fan blade configurations.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is, therefore, provided to describe an exemplary implementation and not to be taken limiting on the scope of the subject matter described in this disclosure. Certain features from different aspects of the following description may be combined to form yet new aspects of the subject matter discussed below.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The terms “upstream” and “downstream” refer to the relative direction with respect to fluid flow in a fluid pathway. For example, “upstream” refers to the direction from which the fluid flows, and “downstream” refers to the direction to which the fluid flows.

Various terms are used herein to describe the orientation of features. As used herein, the orientation of features, forces, and moments are described with reference to the yaw axis, pitch axis, and roll axis of the vehicle associated with the features, forces, and moments. In general, the attached figures are annotated with reference to the axial direction, radial direction, and circumferential direction of the gas turbine associated with the features, forces, and moments. In general, the attached figures are annotated with a set of axes including the axial axis A, the radial axis R, and the circumferential axis C.

In some examples used herein, the term “substantially” is used to describe a relationship between two parts that is within three degrees of the stated relationship (e.g., a substantially colinear relationship is within three degrees of being linear, a substantially perpendicular relationship is within three degrees of being perpendicular, a substantially parallel relationship is within three degrees of being parallel, etc.).

“Including” and “comprising” (and all forms and tenses thereof) are used herein to be open ended terms. Thus, whenever a claim employs any form of “include” or “comprise” (.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

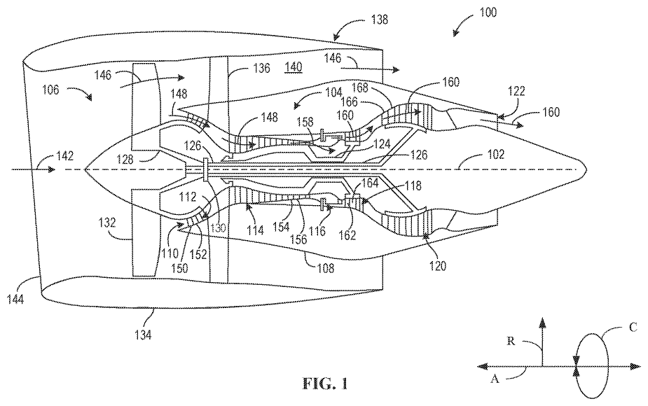

FIG. 1 is a schematic cross-sectional view of a prior art turbofan-type gas turbine engine 100 (“turbofan 100”). As shown in FIG. 1, the turbofan 100 defines a longitudinal or axial centerline axis 102 extending therethrough for reference. In general, the turbofan 100 can include a core section 104 disposed downstream from a fan section 106.

The core section 104 generally includes a substantially tubular outer casing 108 that defines an annular inlet 110. The outer casing 108 can be formed from a single casing or multiple casings. The outer casing 108 encloses, in serial flow relationship, a compressor section having a booster or low pressure compressor 112 (“LP compressor 112”) and a high pressure compressor 114 (“HP compressor 114”), a combustion section 116, a turbine section having a high pressure turbine 118 (“HP turbine 118”) and a low pressure turbine 120 (“LP turbine 120”), and an exhaust section 122. A high pressure shaft or spool 124 (“HP shaft 124”) drivingly couples the HP turbine 118 and the HP compressor 114. A low pressure shaft or spool 126 (“LP shaft 126”) drivingly couples the LP turbine 120 and the LP compressor 112. The LP shaft 126 may also couple to a fan spool or shaft 128 of the fan section 106. In some examples, the LP shaft 126 may couple directly to the fan shaft 128 (e.g., a direct-drive configuration). In alternative configurations, the LP shaft 126 may couple to the fan shaft 128 via a reduction gear 130 (e.g., an indirect-drive or geared-drive configuration).

As shown in FIG. 1, the fan section 106 includes a plurality of fan blades 132 coupled to and extending radially outwardly from the fan shaft 128. An annular fan casing or nacelle 134 circumferentially encloses the fan section 106 and/or at least a portion of the core section 104. The nacelle 134 is supported relative to the core section 104 by a plurality of circumferentially-spaced apart outlet guide vanes 136. Furthermore, a downstream section 138 of the nacelle 134 can enclose an outer portion of the core section 104 to define a bypass airflow passage 140 therebetween.

As illustrated in FIG. 1, air 142 enters an inlet portion 144 of the turbofan 100 during operation thereof. A first portion 146 of the air 142 flows into the bypass airflow passage 140, while a second portion 148 of the air 142 flows into the inlet 110 of the LP compressor 112. One or more sequential stages of LP compressor stator vanes 150 and LP compressor rotor blades 152 coupled to the LP shaft 126 progressively compress the second portion 148 of the air 142 flowing through the LP compressor 112 enroute to the HP compressor 114. Next, one or more sequential stages of HP compressor stator vanes 154 and HP compressor rotor blades 156 coupled to the HP shaft 124 further compress the second portion 148 of the air 142 flowing through the HP compressor 114. This provides compressed air 158 to the combustion section 116 where it mixes with fuel and burns to provide combustion gases 160.

The combustion gases 160 flow through the HP turbine 118 in which one or more sequential stages of HP turbine stator vanes 162 and HP turbine rotor blades 164 coupled to the HP shaft 124 extract a first portion of kinetic and/or thermal energy from the combustion gases 160. This energy extraction supports operation of the HP compressor 114. The combustion gases 160 then flow through the LP turbine 120 where one or more sequential stages of LP turbine stator vanes 166 and LP turbine rotor blades 168 coupled to the LP shaft 126 extract a second portion of thermal and/or kinetic energy therefrom. This energy extraction causes the LP shaft 126 to rotate, thereby supporting operation of the LP compressor 112 and/or rotation of the fan shaft 128. The combustion gases 160 then exit the core section 104 through the exhaust section 122 thereof.

Along with the turbofan 100, the core section 104 serves a similar purpose and sees a similar environment in land-based gas turbines, turbojet engines in which the ratio of the first portion 146 of the air 142 to the second portion 148 of the air 142 is less than that of a turbofan, and unducted fan engines in which the fan section 106 is devoid of the nacelle 134. In each of the turbofan, turbojet, and unducted fan engines, a speed reduction device (e.g., the reduction gearbox 130) may be included between any shafts and spools. For example, the reduction gearbox 130 can be disposed between the LP shaft 126 and the fan shaft 128 of the fan section 106.

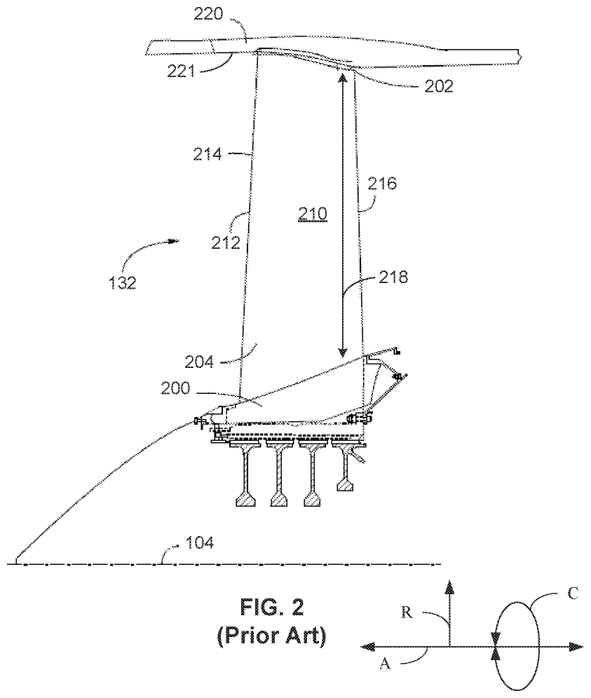

FIG. 2 illustrates the prior art fan section 106 and a portion of the outer casing 108 of FIG. 1 and includes one of the example fan blades 132 of FIG. 1. FIG. 2 further includes a root 200, a tip 202, an exterior body 204, a first side 210, s second side 212, a first edge 214, and a second edge 216.

The fan blade 132 of FIG. 2 radially extends from the root 200 to the tip 202 and defines a length L. The exterior body 204 is the exterior of the fan blade 132 that radially extends from the root 200 to the tip 202. The exterior body 204 can be composed of any suitable material (e.g., a metal (e.g., Titanium, Aluminum, Steel, Nickel alloys, ferrous based alloys, copper-based alloys, etc.), a composite material (e.g., reinforced plastics, fiberglass, metal matrix composites, carbon and/or glass-reinforced polymers, etc.), and a combination thereof). The example exterior body 204 can be any shape and/or thickness. Additionally, each fan blade 132 includes a first side 210 (e.g., a pressure side), a second side 212 (e.g., a suction side), a first edge 214 (e.g., a leading-edge), and a second edge 216 (e.g., a trailing edge). The fan blade 132 has a span 218.

The outer casing 108 of FIG. 2 is configured to channel the incoming air through the fan section 106 to help ensure that the fan section 106 compresses the bulk of the air entering the gas turbine engine 100. By way of example and not limitation, the outer casing 108 can be made of the following: a metal (e.g., Titanium, Aluminum, Steel, Inconel alloys, ferrous based alloys, copper-based alloys, etc.), a composite material (e.g., reinforced plastics, fiberglass, metal matrix composites, carbon and/or glass-reinforced polymers, etc.), and a combination thereof.

In FIG. 2, the outer casing 108 includes a trench filler system 220 and an abradable layer 221. The trench filler system 220 is a layer of the outer casing 108 composed of a fibrous material that circumscribes the fan blades 132 and abradable layer 221. The trench filler system 220 of the outer casing 108 is generally composed of a softer material than the materials of the outer casing 108 that are radially outward of the trench filler system 220. The trench filler system 220 can have any suitable structure (e.g., a honeycomb structure, a sandwich structure, a honeycomb structure with face-sheet(s), etc.) and be composed of any suitable material (e.g., a plastic, a polymer, a reinforced polymer, a composite, etc.). The abradable layer 221 is interposed between the flow path of the engine of the fan section 106 and the trench filler system 220. During normal operation, the fan blades 132 can abrade against (e.g., rub) the abradable layer 221.

During high-stress events (e.g., large bird ingestion, blade outs, etc.), the fan blades 132 can rub through the abradable layer 221 and contact the trench filler system 220. As used herein, a “high-stress event” refers to an engine event that causes the fan blades 132 to exceed the abradable layer 221. During such high stress events, the trench filler system 220 is designed to dissipate/absorb the energy of the fan blades 132, which reduces the stress on the other components of the gas turbine engine 100 caused by the high stress event (e.g., the stress caused by the fan blade 132 contacting the outer casing 108, etc.). In some examples, the stress associated with heavy stress events is the greatest design stress placed on a plurality of the engine components. As such, the use of a trench filler system 220 reduces the maximum design stress on engine components, which reduces their required strength and weight. As such, the trench filler system 220 reduces the overall weight of the gas turbine engine 100.

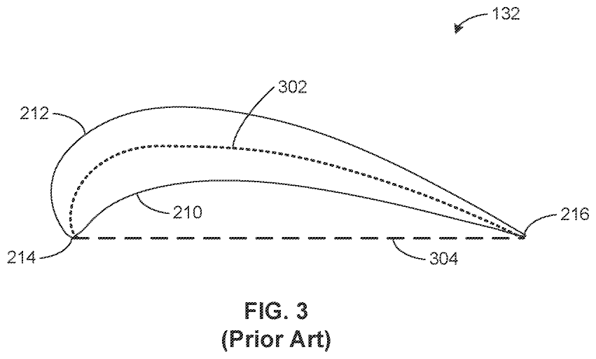

FIG. 3 is a cross-sectional view of the fan blade 132 of FIGS. 1 and 2. In FIG. 3, the blade has a camber line 302 that extends between the leading edge 214 and trailing edge 216 while remaining equidistance between the first side 210 and second side 212. In FIG. 3, the blade 132 has a chord line 304 that extends directly between the leading edge 214 and trailing edge 216. The shape of the fan blade 132 is illustrated in FIG. 3, the fan blades, including those described herein, can have any suitable shape and/or size (e.g., different maximum cambers, different locations of maximum thickness, etc.).

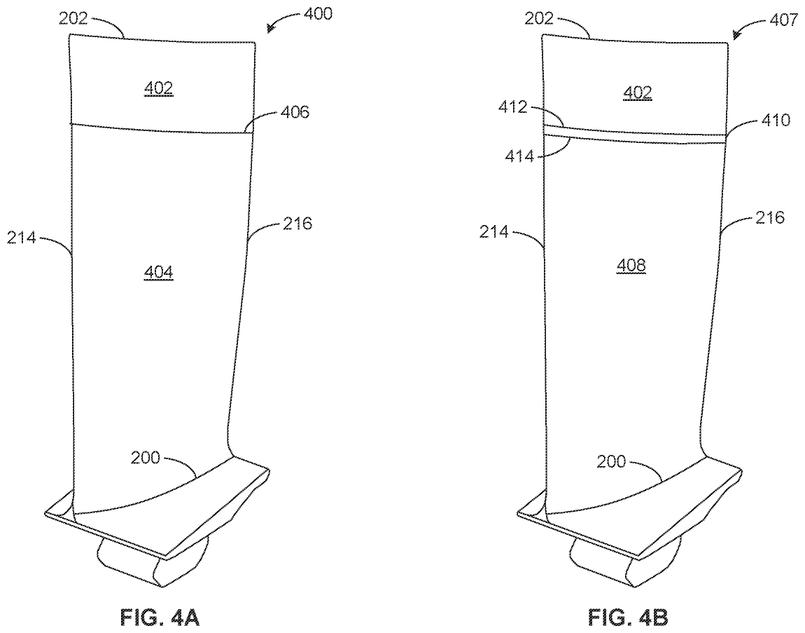

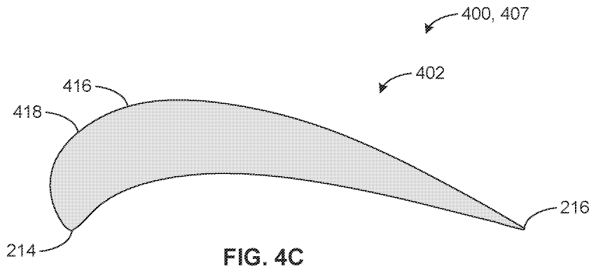

The following examples refer to fan blades, similar to the fan blades described with reference to FIG. 1 and the fan blades of FIGS. 2 and 3, except that the fan blades have been modified to include tip portions with features for frangibility or breakability, in accordance with this disclosure. When the same element number is used in connection with FIGS. 4A-6, as was used in FIGS. 1-3, it has the same meaning unless indicated otherwise.

FIG. 4A is a perspective view of an example fan blade 400 including a lattice tip portion 402 implemented in accordance with the teachings of this disclosure. The example fan blade includes a root 200, a tip 202, a leading edge 214, and a trailing edge 216. The fan blade 400 additionally includes a root portion 404, which is separated by a boundary 406.

The tip portion 402 includes a lattice structure disposed within a thin walled cavity of the tip portion 402. That is, the tip portion 402 of FIG. 4A is not a solid feature but includes a structure with spaces (e.g., pockets, voids, etc.) left in during the manufacturing process. The lattice structure of the tip portion can be of any suitable configuration (e.g., square internal walls, diamond internal walls, honeycomb internal walls, polygonal internal walls, etc.). Additionally or alternatively, the tip portion 402 can include another type of internal structure with spaces. For example, the tip portion 402 can include a ribbed structure and/or a trussed structure. The internal structure of the tip portion 402 makes the tip portion 402 frangible by facilitating the fragmentation and abrasion of the fan blade 400 during high-stress events, which reduces the load on other components resulting from the rubbing of the fan blade and the fan casing. Particularly, the lattice structure of the tip portion 402 is configured to cause the tip portion 402 to fragment when exposed to a threshold force and not to fragment when exposed to forces below the threshold force. In some examples, this threshold force corresponds to the forces encountered by the blade 400 during high-stress events. As such, the employment of the fan blade 400 allows a gas turbine to not include a trench filler system. An example of the internal structure of the tip portion 402 is depicted in FIG. 4C.

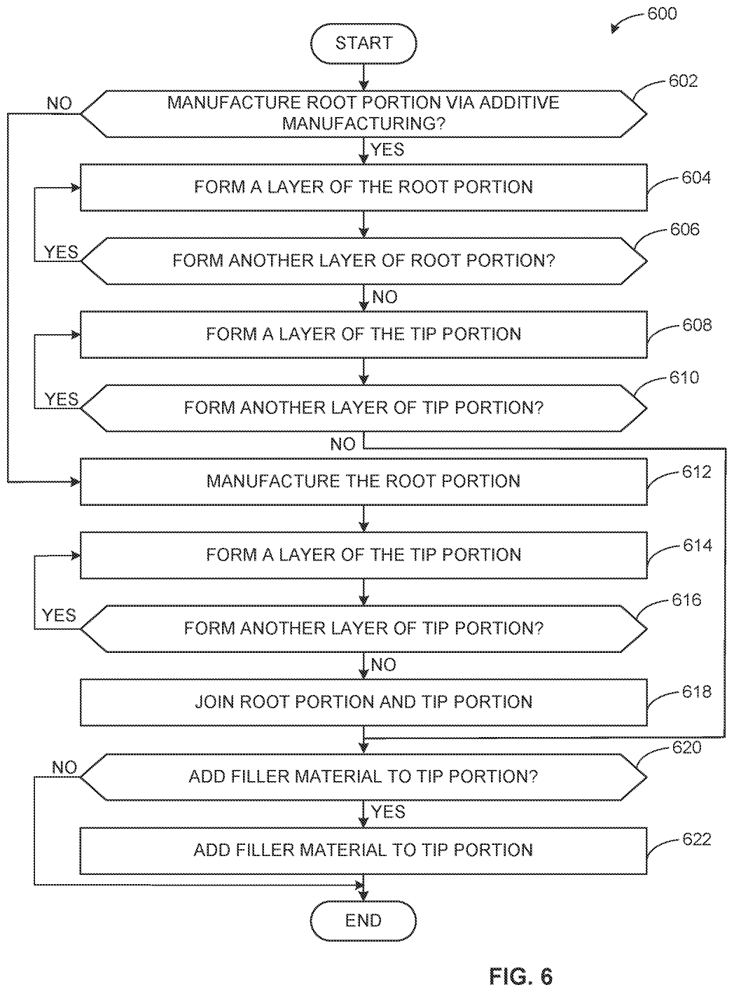

The fan blade 400 can be coupled within a gas turbine engine (e.g., the gas turbine engine 100 of FIG. 1, etc.). The fan blade 400 is a unitary part (e.g., composed of a monolithic whole, etc.). That is, the tip portion 402 and the root portion 404 of the fan blade 400 are unitary and manufactured via the same process. In some examples, the fan blade 400 is manufactured via additive manufacturing (e.g., powder bed fusion, material extrusion, material jetting, etc.). In other examples, the fan blade 400 can be manufactured via any other suitable method (e.g., machining, casting, etc.). The fan blade 400 can be composed of any suitable material (e.g., a metal (e.g., Titanium, Aluminum, Steel, Nickel alloys, ferrous based alloys, copper-based alloys, etc.), a composite material (e.g., reinforced plastics, fiberglass, metal matrix composites, carbon and/or glass-reinforced polymers, etc.), and a combination thereof). An example process of manufacturing the fan blade 400 is described below in conjunction with FIG. 6.

In some examples, the tip portion 402 can be filled with a filler material during the manufacturing process. The filler material can include a resin, an adhesive, a polymer, or a suitable combination thereof. In some examples, a portion of the tip portion 402 can be filed with a filler material. In some examples, the filler material can change a property (e.g., a harmonic property, a mechanical property, a thermal property, etc.) to be more favorable to the performance of the gas turbine engine (e.g., the gas turbine engine 100 of FIG. 1, etc.) the fan blade 400 is disposed in.

The boundary 406 is the spanwise location of the fan blade 400 at which the tip portion 402 begins at. That is, the boundary 406 is the lowest point of the lattice structure of the tip portion 402. In FIG. 4A, the boundary 406 is the same spanwise location along the chord of the fan blade 400. In some examples, the boundary 406 can be disposed between 60% and 80% of the span of the fan blade 400. In other examples, the boundary 406 can be at any other location along the span of the fan blade 400. In some examples, the boundary 406 can be irregular along the chord of the fan blade 400. For example, the boundary 406 can have a different spanwise location near the leading edge 214 of the fan blade 400 (e.g., 60% of the span, etc.) and the trailing edge 216 of the fan blade 400 (e.g., 80% of the span, etc.). Additionally or alternatively, the boundary 406 can any suitable profile along the chord between the leading edge 214 and the trailing edge 216 (e.g., linear, parabolic, quadratic, sinusoidal, etc.).

FIG. 4B is a perspective view of another example fan blade 407 including a lattice tip portion 402 implemented in accordance with the teachings of this disclosure. Like the fan blade 400 of FIG. 4A, the fan blade 407 includes the root 200, the tip 202, the leading edge 214, the trailing edge 216, and the lattice tip portion 402. The fan blade 407 further includes a root portion 408 and a boundary portion 410. The tip portion 402 is separated from the boundary portion by a first boundary 412. The root portion 408 is separated from the boundary portion 410 by a second boundary 414.

Unlike the fan blade 400, the fan blade 407 includes the boundary portion 410, which couples the tip portion 402 to the root portion 408. In some examples, the boundary portion 410 is formed via a weld (e.g., a friction weld, a Thompson friction weld, etc.) and/or another suitable joining process. In FIG. 4B, the fan blade 407 is not a unitary part. In such examples, the tip portion 402 is manufactured via a first manufacturing process (e.g., additive manufacturing, etc.) and the root portion 408 is manufactured via a second manufacturing process (e.g., negative manufacturing, casting, etc.). An example process of manufacturing the fan blade 407 is described below in conjunction with FIG. 6.

The first boundary 412 is the spanwise location of the fan blade 407 at which the tip portion 402 begins. That is, the first boundary 412 is the lowest point of the lattice structure of the tip portion 402. In FIG. 4B, the first boundary 412 is the same spanwise location along the chord of the fan blade 407. In some examples, the first boundary 412 can be disposed between 60% and 80% of the span of the fan blade 407. In other examples, the first boundary 412 can be at any other location along the span of the fan blade 407. In some examples, the first boundary 412 can be irregular along chord of the fan blade 407. For example, the first boundary 412 can have a different spanwise location near the leading edge 214 of the fan blade 407 (e.g., 60% of the span, etc.) and the trailing edge 216 of the fan blade 407 (e.g., 80% of the span, etc.). Additionally or alternatively, the first boundary 412 can have any suitable profile along the chord between the leading edge 214 and the trailing edge 216 (e.g., linear, parabolic, quadratic, sinusoidal, etc.).

The second boundary 414 is the spanwise location of the fan blade 407 at which the root portion 408 ends. In FIG. 4B, the second boundary 414 is at a consistent spanwise location (e.g., between 55% and 70% of the span) and parallel to the first boundary 412. In other examples, the second boundary 414 can be at any other location along the span of the fan blade 407 and can have a different profile than the first boundary 412 (e.g., linear, parabolic, quadratic, sinusoidal, etc.). In FIG. 4B, the profile and distance between the first boundary 412 and the second boundary 414 are defined by the size and shape of the boundary portion 410. For example, if the boundary portion 410 has a consistent spanwise location and is 5% of the span of the fan blade 407, the boundaries 412, 414 can have a corresponding profile and position (e.g., 65% and 70% of the span, 75% and 80% of the span, etc.).

FIG. 4C is a cross-sectional view of the tip portion 402 of the fan blades 400, 407 of FIGS. 4A and/or FIG. 4B. In the illustrated example of 4C, an example lattice structure 416 of the tip portion 402 is disposed within the entire cross-section. That is, the lattice structure 416 is disposed within an example thin walled cavity 418 in the tip portion 402. In other examples, the lattice structure 416 can be disposed at any other suitable portion of the cross-section of the tip portion 402 (e.g., a thick walled cavity, etc.). In FIG. 4C, the lattice structure 416 has a diamond-shaped cross-section. In other examples, the lattice structure 416 can have any other suitable cross-section.

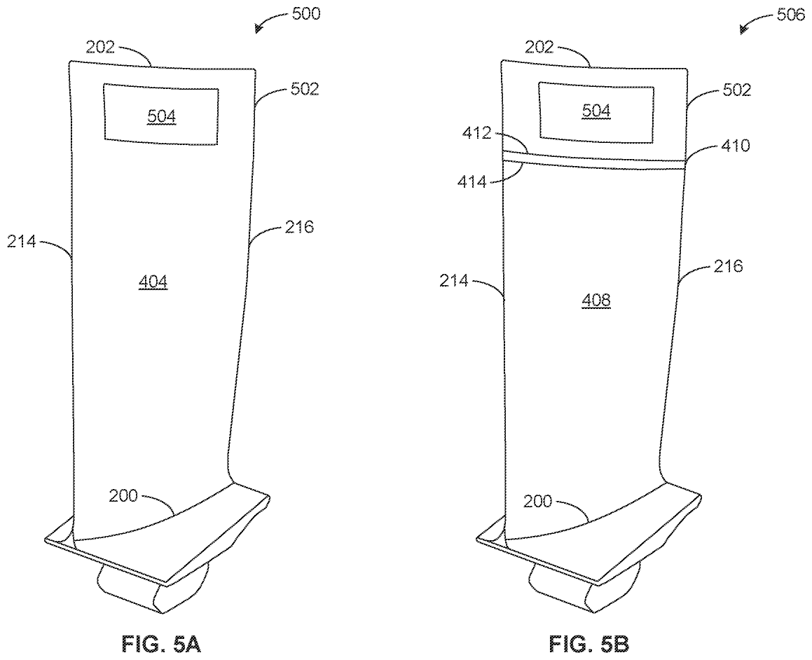

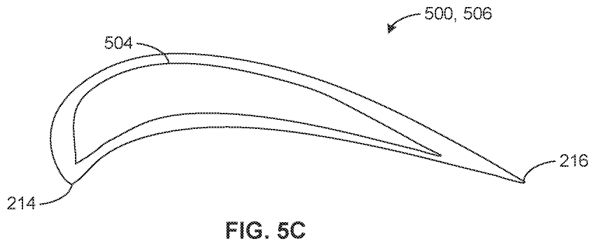

FIG. 5A is a perspective view of an example fan blade 500 including a hollow tip portion 502 implemented in accordance with the teachings of this disclosure. The example fan blade 500 includes a root 200, a tip 202, a leading edge 214, and a trailing edge 216. The fan blade 500 additionally includes the root portion 404 of FIG. 4A. Unless described otherwise, the root portion 404 has the same properties as those described in conjunction with FIG. 4A.

The fan blade 500 can be coupled within a gas turbine engine (e.g., the gas turbine engine 100 of FIG. 1, etc.). The fan blade 500 is a unitary part (e.g., composed of a monolithic whole, etc.). That is, the tip portion 502 and the root portion 404 of the fan blade 500 are unitary and manufactured via a same process. In some examples, the fan blade 500 is manufactured via additive manufacturing (e.g., powder bed fusion, material extrusion, material jetting, etc.). In other examples, the fan blade 500 can be manufactured via any other suitable method (e.g., machining, casting, etc.). The fan blade 500 can be composed of any suitable material (e.g., a metal (e.g., Titanium, Aluminum, Steel, Nickel alloys, ferrous based alloys, copper based alloys, etc.), a composite material (e.g., reinforced plastics, fiberglass, metal matrix composites, carbon and/or glass reinforced polymers, etc.), and a combination thereof). An example process of manufacturing the fan blade 500 is described below in conjunction with FIG. 6.

The tip portion 502 includes a cavity 504. In FIG. 5A, the cavity 504 generally has the same three-dimensional shape as the overall tip portion 502. In other examples, the cavity 504 can have any other suitable shape (e.g., spherical, cylindrical, conical, cuboid, pyramidal, prismatic, etc.) Additionally or alternatively, the cavity 504 can include multiple cavities (two cavities, three cavities, four cavities, etc.) that can also have any suitable shape (e.g., e.g., spherical, cylindrical, conical, cuboid, pyramidal, prismatic, etc.). In such examples, the multiple cavities can be interconnected (e.g., forming a unitary shape, etc.) and/or can be separated by walls. The cavity 504 of the tip portion 502 facilitates the fragmentation and abrasion of the fan blade 500 during high-stress events, which reduces the load on other components resulting from the rubbing of the fan blade and the fan casing. Particularly, the cavity 504 is configured to cause the tip portion 502 to fragment when exposed to a threshold force and not to fragment when exposed to forces below the threshold force. In some examples, this threshold force corresponds to the forces encountered by the blade 500 during high-stress events. As such, the employment of the fan blade 500 allows a gas turbine to not include a trench filler system. An example of the internal structure of the tip portion 502 is depicted in FIG. 5C.

In FIG. 5A, the upper boundary of the cavity 504 is located at 90% of the span of the fan blade 500 and the lower portion of the cavity is located at 70% of the span of the fan blade 500. In other examples, the upper and lower boundaries of the cavity 504 and overall spanwise length of the cavity 504 can be any other suitable location (e.g., 60% and 80% of the fan blade 500 span, 65% and 80% of the fan blade 500 span, etc.)

In some examples, the cavity 504 can be filled with a filler material during the manufacturing process. The filler material can include a resin, an adhesive, a polymer, or a suitable combination thereof. In some examples, the cavity 504 can be filled with a filler material. In some examples, the filler material can change a property (e.g., a harmonic property, a mechanical property, a thermal property, etc.) to be more favorable to the performance of the gas turbine engine (e.g., the gas turbine engine 100 of FIG. 1, etc.) in which the fan blade 500 is disposed.

FIG. 5B is a perspective view of another example fan blade 506 including the tip portion 502 and cavity 504 implemented in accordance with the teachings of this disclosure. Like the fan blade 506 of FIG. 4B, the fan blade 506 includes the root 200, the tip 202, the leading edge 214, the trailing edge 216, the tip portion 502, and the cavity 504. The fan blade 506 further includes the root portion 408 of FIG. 4B, the boundary portion 410 of FIG. 4B, the first boundary 412 of FIG. 4B, and the second boundary 414 of FIG. 4B. Unless described otherwise herein, the root portion 408, the boundary portion 410, the first boundary 412, and the second boundary 414 have the same properties as the properties described in conjunction with FIG. 4A.

Unlike the fan blade 500, the fan blade 506 includes the boundary portion 410, which couples the tip portion 502 to the root portion 408. In FIG. 5B, the fan blade 506 is not a unitary part. In such examples, the tip portion 502 is manufactured via a first manufacturing process (e.g., additive manufacturing, etc.) and the root portion 408 is manufactured via a second manufacturing process (e.g., negative manufacturing, casting, etc.). An example process of manufacturing the fan blade 506 is described below in conjunction with FIG. 6.

FIG. 5C is a cross-sectional view of the tip portion 502 of the fan blades 500, 506 of FIGS. 5A and/or FIG. 5B. The cross-sectional view illustrated in FIG. 5C, the cavity 504 has the same cross-sectional shape as the tip portion 502. Additionally or alternatively, the cross-section of the cavity 504 can be the same as the cross-section of the tip portion 502 along the entire span of the tip portion 502. In other examples, the cavity 504 can any suitable cross-section corresponding to the three-dimensional shape of the cavity 504. The cavity 504 can be any suitable chordwise location in the cross-section of the tip portion.

In FIG. 5C, the leading edge boundary of the cavity 504 is located at 30% of the chord of the fan blade 500, and the trailing portion of the cavity is located at 70% of the chord of the fan blade 500. In other examples, the upper and lower boundaries of the cavity 504 and overall spanwise length of the cavity 504 can be any other suitable location (e.g., 40% and 90% of the fan blade 500 span, 10% and 80% of the fan blade 500 span, etc.).

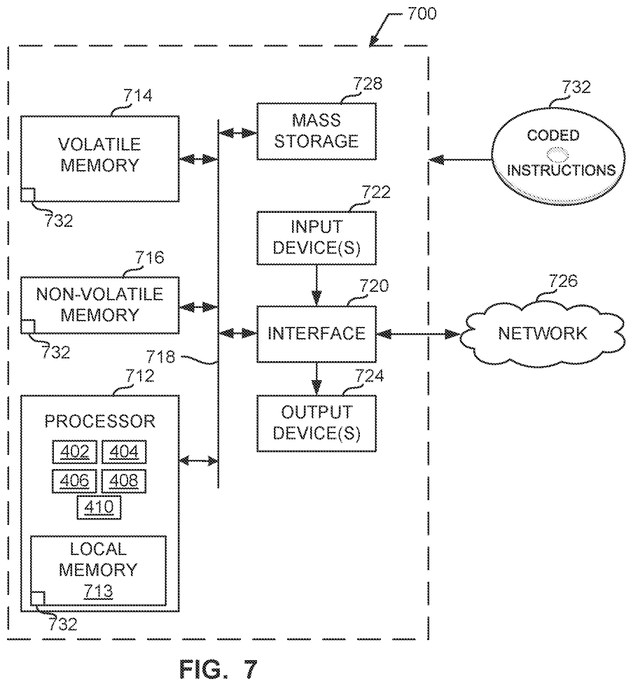

A flowchart representative of example manufacturing steps, hardware logic, machine-readable instructions, hardware-implemented state machines, and/or any combination thereof for manufacturing the fan blades 400, 407, 500, 506 is shown in FIG. 6. The machine-readable instructions may be one or more executable programs or portion(s) of an executable program for execution by a computer processor and/or processor circuitry, such as the processor 712 shown in the example processor platform 700 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowchart illustrated in FIG. 6, many other methods of manufacturing the fan blades 400, 407, 500, 506 can be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., portions of instructions, code, representations of code, etc.) that may be utilized to create, manufacture, and/or produce machine-executable instructions. For example, the machine-readable instructions may be fragmented and stored on one or more storage devices and/or computing devices (e.g., servers) located at the same or different locations of a network or collection of networks (e.g., in the cloud, in edge devices, etc.).

The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or another machine. For example, the machine-readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or another device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

FIG. 6 illustrates an example flowchart representative of an example process 600 to be used to manufacture the fan blades 400, 407, 500, 506 of FIGS. 4A, 4B, 5A, and/or 5B. The blocks 602-622 of the example process 600 can be executed by hardware components (e.g., CNC machines, additive manufacturing machines, etc.) and/or human action (e.g., machining, etc.) and/or any suitable combination thereof In some examples, the processor platform 700 of FIG. 7 can cause the execution of all or some of the blocks 602-622. The example processor platform 700 can be included in an additive manufacturing apparatus and/or other manufacturing apparatus and/or be separate but in communication with to control an additive manufacturing apparatus and/or other manufacturing apparatus, for example.

The process 600 begins at block 602. At block 602, if the root portion is to be manufactured via additive manufacturing, the process 600 advances to block 604 (e.g., the root portion 404 of FIGS. 4A, 5A, etc.). If the root portion 404 is not to be manufactured via additive manufacturing, the process 600 advances to block 612 (e.g., the root portion 408 of FIGS. 4B, 5B, etc.).

At block 604, a layer of the root portion 408 is formed. For example, a layer of the root portion 408 is fused the first layer via an additive manufacturing process (e.g., powder bed fusion, binder fusion, etc.) from a bed of substrate material (e.g., a powdered metal, a powdered polymer, a powdered resin, a powdered plastic, etc.). In other examples, the layer of the root portion 408 can be deposited (e.g., extruded, etc.) via an additive manufacturing process (e.g., material extrusion, material jetting, etc.). In other examples, any other type of additive manufacturing can be used to manufacture the root portion 408 (e.g., sheet lamination, vat polymerization, directed energy deposition, etc.).

At block 606, if another layer of the root portion 408 is to be formed, the process 600 returns to block 604. If another layer of the root portion 408 is not to be formed, the process 600 advances to block 608. For example, additionally layers can be formed if additional layers are to finish the object being printed. Additionally or alternatively, a computing system (e.g., the computer including the controller of the additive manufacturing process, etc.) can analyze a part geometry file to determine if another layer is to be deposited. In some examples, the root portion 408 can undergo a post-processing process (e.g., surface finishing, grinding, etc.) after the additive manufacturing process.

At block 608, a layer of the tip portion 402, 502 is formed. For example, a layer of the tip portion 402, 502 is fused the first layer via an additive manufacturing process (e.g., powder bed fusion, binder fusion, etc.) from a bed of substrate material (e.g., a powdered metal, a powdered polymer, a powdered resin, a powdered plastic, etc.). In other examples, the layer of the tip portion 402, 502 can be deposited (e.g., extruded, etc.) via an additive manufacturing process (e.g., material extrusion, material jetting, etc.). In other examples, any other type of additive manufacturing can be used to manufacture the tip portion 402, 502 (e.g., sheet lamination, vat polymerization, directed energy deposition, etc.). The deposited layer of the tip portion can include the lattice structure 416 (e.g., corresponding to the tip portion 402 of FIGS. 4A and 4B, etc.) or the cavity 504 (e.g., corresponding to the tip portion 502 of FIGS. 5A and 4B, etc.).

At block 610, if another layer of the tip portion 402, 502 is to be formed, the process 600 returns to block 608. If another layer of the tip portion 402, 502 is not to be formed, the process 600 advances to block 620. For example, additionally layers can be formed if additional layers are to finish the object being printed. Additionally or alternatively, a computing system (e.g., the computer including the controller of the additive manufacturing process, etc.) can analyze a part geometry file to determine if another layer is to be deposited. In some examples, the tip portion 402, 502 can undergo a post-processing (e.g., surface finishing, grinding, etc.) after the additive manufacturing process.

At block 612, the root portion 404 is manufactured via non-additive manufacturing techniques. For example, the root portion 404 can be manufactured via machining (e.g., via a mill, etc.). In other examples, the root portions 404 can be manufactured via casting (e.g., mold casting, die casting, etc.). In some examples, the root portion 404 can be assembled and/or formed from multiple parts (e.g., via welding, a fastener, a chemical adhesive, etc.). In some examples, the root portion 408 can undergo a post-processing process (e.g., surface finishing, grinding, etc.) after the manufacturing process.

At block 614, a layer of the tip portion 402, 502 is formed. For example, a layer of the tip portion 402, 502 is fused to the first layer via an additive manufacturing process (e.g., powder bed fusion, binder fusion, etc.) from a bed of substrate material (e.g., a powdered metal, a powdered polymer, a powdered resin, a powdered plastic, etc.). In other examples, the layer of the tip portion 402, 502 can be deposited (e.g., extruded, etc.) via an additive manufacturing process (e.g., material extrusion, material jetting, etc.). In other examples, any other type of additive manufacturing can be used to manufacture the tip portion 402, 502 (e.g., sheet lamination, vat polymerization, directed energy deposition, etc.). The deposited layer of the tip portion can include the lattice structure 416 (e.g., corresponding to the tip portion 402 of FIGS. 4A and 4B, etc.) or the cavity 504 (e.g., corresponding to the tip portion 502 of FIGS. 5A and 4B, etc.).

At block 616, if another layer of the tip portion 402, 502 is to be formed, the process 600 returns to block 614. If another layer of the tip portion 402, 502 is not to be formed, the process 600 advances to block 618. For example, additionally layers can be formed if additional layers are to finish the object being printed. Additionally or alternatively, a computing system (e.g., the computer including the controller of the additive manufacturing process, etc.) can analyze a part geometry file to determine if another layer is to be deposited. In some examples, the tip portion 402, 502 can undergo a post-processing process (e.g., surface finishing, grinding, etc.) after the additive manufacturing process.

At block 618, the tip portion 402, 502 is joined with the root portion 408. For example, the tip portion 402, 502 can be fused via a friction weld to form the fan blade 407, 506, respectively. In other examples, the tip portion 402, 502 can be joined via any other suitable technique (e.g., a different type of weld, a chemical adhesive, etc.).

At block 620, if the tip portion 402, 502 is to be filled with a filler material, the process 600 advances to block 622. If the tip portion 402, 502 is not be filled with a filler material, the process 600 ends.

At block 622, the tip portion 402, 502 is filled with a filler material. For example, the lattice structure of the tip portion 402 can be filled with filler material. The cavity 504 of the tip portion 502 can be filled with filler material. In some examples, the filler material includes a polymer, resin, plastic, and/or any combination thereof. The process 600 ends.

FIG. 7 is a block diagram of an example processor platform 700 that can be used to execute the process 600 of FIG. 6. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or other wearable device, a controller, an additive manufacturing apparatus, or any other type of computing device. For example, the processor platform 700 can be included in an additive manufacturing apparatus and/or other manufacturing apparatus and/or be separate but in communication with to control an additive manufacturing apparatus and/or other manufacturing apparatus.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 712 implements an additive manufacturing device, a computer numerical control (CNC) device, and/or any other type of device that can be used to manufacture the fan blades 400, 407, 500, 506.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIG. 5 may be stored in the mass storage device 728, in the volatile memory 714, in the non-volatile memory 716, and/or on a removable non-transitory computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Further aspects of the disclosure are provided by the subject matter of the following clauses:

Example 1 is an airfoil for use in a gas turbine engine, the airfoil comprising a root portion to be coupled to a disk of the gas turbine engine, a tip portion including a cavity disposed therein, the tip portion to be disposed adjacent to an abradable layer of the gas turbine engine, and wherein the tip portion and cavity are configured to fragment when exposed to a threshold force corresponding to the tip portion exceeding the abradable layer.

Example 2 is the airfoil of any proceeding clause, wherein the tip portion is manufactured via additive manufacturing.

Example 3 is the airfoil of any proceeding clause, wherein the root portion is a non-additively manufactured portion, the tip portion is coupled to the root portion via a friction weld.

Example 4 is the airfoil of any proceeding clause, wherein the root portion and the tip portion are unitary.

Example 5 is the airfoil of any proceeding clause, wherein the cavity includes a lattice structure.

Example 6 is the airfoil of any proceeding clause, wherein the cavity includes a filler material disposed therein, the filler material including at least of an adhesive, a polymer, or a resin.

Example 7 is the airfoil of any proceeding clause, wherein the airfoil is to be disposed within the gas turbine engine that does not include a trench filler system.

Example 8 is the airfoil of any proceeding clause, wherein the airfoil is a fan blade.

Example 9 is the airfoil of any proceeding clause, wherein the cavity includes a first spanwise edge and a second spanwise edge, the first spanwise edge adjacent to a tip of the airfoil, the second spanwise edge disposed between 70% of a span of the airfoil and 90% of the span of the airfoil.

Example 10 is the airfoil of any proceeding clause, wherein the cavity includes a first chordwise edge and a second chordwise edge, the first chordwise edge disposed between a leading tip of the airfoil and 30% of a chord of the airfoil, the second chordwise edge disposed between 70% of the chord of the airfoil and a trailing tip of the airfoil.

Example 11 is a gas turbine engine, comprising a casing including an abradable layer, a rotor disk, and an airfoil coupled to the rotor disk, the airfoil comprising a root portion coupled to a disk of the gas turbine engine, a tip portion including a cavity disposed therein, the tip portion disposed adjacent to an abradable layer of the gas turbine engine, and wherein the tip portion and cavity are configured to fragment when exposed to a threshold force corresponding to the tip portion exceeding the abradable layer.

Example 12 is the gas turbine engine of any proceeding clause, wherein the tip portion is manufactured via additive manufacturing.

Example 13 is the gas turbine engine of any proceeding clause, wherein the root portion is a conventionally manufactured portion, the tip portion is coupled to the root portion via a friction weld.

Example 14 is the gas turbine engine of any proceeding clause, wherein the root portion and the tip portion are unitary.

Example 15 is the gas turbine engine of any proceeding clause, wherein the cavity includes a lattice structure.

Example 16 is the gas turbine engine of any proceeding clause, wherein the cavity includes a filler material disposed therein, the filler material including at least of an adhesive, a polymer, or a resin.

Example 17 is the gas turbine engine of any proceeding clause, wherein the gas turbine engine does not include a trench filler system.

Example 18 is the gas turbine engine of any proceeding clause, further including a fan section, the fan section including the rotor disk and the airfoil.

Example 19 is the gas turbine engine of any proceeding clause, wherein the cavity includes a first spanwise edge and a second spanwise edge, the first spanwise edge adjacent to a tip of the airfoil, the second spanwise edge disposed between 70% of a span of the airfoil and 90% of the span of the airfoil.

Example 20 is the gas turbine engine of any proceeding clause, wherein the cavity includes a first chordwise edge and a second chordwise edge, the first chordwise edge disposed between a leading tip of the airfoil and 30% of a chord of the airfoil, the second chordwise edge disposed between 70% of the chord of the airfoil and a trailing tip of the airfoil. The following claims are hereby incorporated into this Detailed Description by this reference, with each claim standing on its own as a separate embodiment of the present disclosure.

1. An airfoil for use in a gas turbine engine, the airfoil comprising:
a root portion to be coupled to a disk of the gas turbine engine
a tip portion including a cavity disposed therein, the tip portion to be disposed adjacent to an abradable layer of the gas turbine engine;
a boundary portion coupling the root portion to the tip portion, the boundary portion including a welded joint; and
wherein the tip portion and the cavity are configured to fragment when exposed to a threshold force corresponding to the tip portion exceeding the abradable layer.

2. The airfoil of claim 1, wherein the tip portion is manufactured via additive manufacturing.

3. (canceled)

4. (canceled)

5. The airfoil of claim 1, wherein the cavity includes a lattice structure.

6. The airfoil of claim 1, wherein the cavity includes a filler material disposed therein, the filler material including at least one of an adhesive, a polymer, or a resin.

7. The airfoil of claim 1, wherein the airfoil is to be disposed within the gas turbine engine that does not include a trench filler system.

8. The airfoil of claim 1, wherein the airfoil is a fan blade.

9. The airfoil of claim 1, wherein the cavity includes a first spanwise edge and a second spanwise edge, the first spanwise edge adjacent to a tip of the airfoil, the second spanwise edge disposed between 70% of a span of the airfoil and 90% of the span of the airfoil.

10. The airfoil of claim 1, wherein the cavity includes a first chordwise edge and a second chordwise edge, the first chordwise edge disposed between a leading tip of the airfoil and 30% of a chord of the airfoil, the second chordwise edge disposed between 70% of the chord of the airfoil and a trailing tip of the airfoil.

11. A gas turbine engine, comprising:
a casing including an abradable layer;
a rotor disk; and
an airfoil coupled to the rotor disk, the airfoil comprising:
a root portion coupled to the rotor disk of the gas turbine engine;
a tip portion including a cavity disposed therein, the tip portion disposed adjacent to the abradable layer of the gas turbine engine;
a boundary portion coupling the root portion to the tip portion, the boundary portion including a welded joint and
wherein the tip portion and cavity are configured to fragment when exposed to a threshold force corresponding to the tip portion exceeding the abradable layer.

12. The gas turbine engine of claim 11, wherein the tip portion is manufactured via additive manufacturing.

13. (canceled)

14. (canceled)

15. The gas turbine engine of claim 11, wherein the cavity includes a lattice structure.

16. The gas turbine engine of claim 11, wherein the cavity includes a filler material disposed therein, the filler material including at least one of an adhesive, a polymer, or a resin.

17. The gas turbine engine of claim 11, wherein the gas turbine engine does not include a trench filler system.

18. The gas turbine engine of claim 11, further including a fan section, the fan section including the rotor disk and the airfoil.

19. The gas turbine engine of claim 11, wherein the cavity includes a first spanwise edge and a second spanwise edge, the first spanwise edge adjacent to a tip of the airfoil, the second spanwise edge disposed between 70% of a span of the airfoil and 90% of the span of the airfoil.

20. The gas turbine engine of claim 11, wherein the cavity includes a first chordwise edge and a second chordwise edge, the first chordwise edge disposed between a leading tip of the airfoil and 30% of a chord of the airfoil, the second chordwise edge disposed between 70% of the chord of the airfoil and a trailing tip of the airfoil.
